(19) United States
(12) Patent Application Publication
(10) Pub. No.: US 2008/0072506 A1
(43) Pub. Date: Mar. 27, 2008

(54) Vinyl door jamb and casing unit

(76) Inventor: Roger L. LeGoff, Denmark, ME (US)

Correspondence Address: BOHAN, MATHERS & ASSOCIATES, LLC, PO BOX 17707, PORTLAND, ME, 04112-8707, US

(21) Appl. No.: 11/526,930

(22) Filed: Sep. 26, 2006

(51) Int. Cl. E06B 1/04

(52) U.S. Cl. 52/204.1

(57) ABSTRACT

A doorjamb unit made of PVC that provides a combination doorjamb and casing. The doorjamb unit has a door jamb section and a casing section, which fits around the doorway framing and interior jamb. A seal is provided along a vertical edge of the jamb section to seal the gap between jamb and door when the door is closed. The doorjamb unit is quickly and easily installed and provides a pleasing, finished appearance.

### BACKGROUND INFORMATION

1. Field of the Invention

The invention relates to the field of doors. More particularly, the invention relates to a door jamb and casing for the outside doorway of a building.

2. Description of the Prior Art

Door jambs and casings for residential and other non-industrial structures are generally made of wood on site when a door is first installed. There are many drawbacks to such jambs and casings. Proper installation of the door jamb and casing requires skilled carpentry work. Initially, the joints in the doorjamb are tight and prevent air leakage, but the tightness of the joints naturally deteriorates with time, for a number of reasons: the wood absorbs moisture, the paint peels, mildew builds up, and the wood begins to rot. Wood door jambs thus require constant care to maintain their aesthetic appearance and a good seal.

Today, building owners frequently seek low-maintenance solutions for exterior door jambs and casings, which will contribute to the desired aesthetic appearance of a neat, well-maintained door. Some door jambs are cladded with painted aluminum, which has been bent to shape to cover the door jamb and casing, starting at the weather strip adjacent the door and extending to the nailing flange of the casing. This solution, although reducing the year-to-year maintenance burden, initially requires a significant input of time and money. The aluminum clad must be handled with care during installation, as it scratches and dents easily. It must also be installed to provide sufficient room to accommodate thermal expansion, yet provide a good seal in very cold, as well as very warm temperatures. Failure to provide the expansion room will cause unsightly or undesired ripples to develop on the surface of the clad. Furthermore, every day useage exacts a toll and the cladding around a doorway may be marred or dented after it is installed. For example, moving large or oversized items, such as furniture, or sending misguided objects through the door, frequently results in damage to the cladding.

What is needed, therefore, is a doorjamb unit that is easy to install, without requiring special skills. What if further needed is such a door jamb unit that provides a tight, sealed fit around the wall framing and the door, and that provides an aesthetically pleasing, maintenance-free, and finished appearance.

### BRIEF SUMMARY OF THE INVENTION

The present invention is a vinyl door jamb unit that attaches to the wall framing of a doorway. The door jamb unit is an L-shaped construction that fits around the wall framing and the interior jamb, and forms the casing and the door jamb. The doorjamb unit comprises a single extruded component that includes both the doorjamb and the casing components. Alternatively, the doorjamb unit comprises an extruded elongate door jamb component and an extruded elongate casing component, the two components securely connecting to each other with a J-channel connection, such that the doorjamb unit is installed as a single component.

A header, also an extruded elongate component, attaches to the upper end of the door jamb unit and extends across the upper end of the door to provide a complete casing around the door frame. Attached to the edge of the door jamb that faces the door is a seal that provides an air-tight seal between door jamb and door when the door is closed. The edge of the casing that faces toward the wall siding has a channel for receiving conventional wall siding. The doorjamb and casing components of the door jamb unit, including the header components, are made of extruded PVC or other suitable polymeric material. The seal is made of a suitable seal material that is heat-welded or otherwise attached to the jamb. The door jamb unit is easy to install and provides an aethetically pleasing, finished appearance that is maintenance-free.

### BRIEF DESCRIPTION OF THE DRAWINGS

The present invention is described with reference to the accompanying drawings. In the drawings, like reference numbers indicate identical or functionally similar elements.

FIG. 1 is a front elevational view of a door, showing the door jamb unit according to the invention mounted around the door.

FIG. 2 is a perspective view of the doorjamb unit according to the invention.

FIG. 3 is a top plane view of the doorjamb unit, shown as a single component construction.

FIG. 4 is a top plane view of the door jamb unit, used together with an overhead door.

FIG. 5 is a top plane view of the door jamb unit according to the invention, shown as a two-component construction.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

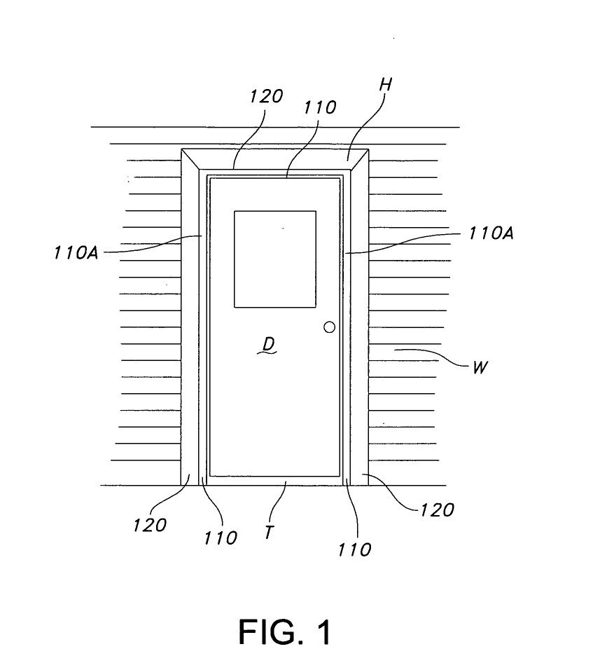

FIG. 1 is a front elevational view of a doorjamb unit 100 according to the invention and a conventional door D assembled in a wall W. The doorjamb unit 100 is an elongate assembly that comprises a jamb section 110 and a casing section 120. A header H is incorporated into the doorjamb unit 100 and is made up of the same jamb section 110 and casing section 120 used for the vertical portions of the door jamb unit 100. A conventional threshold T is provided below the door D.

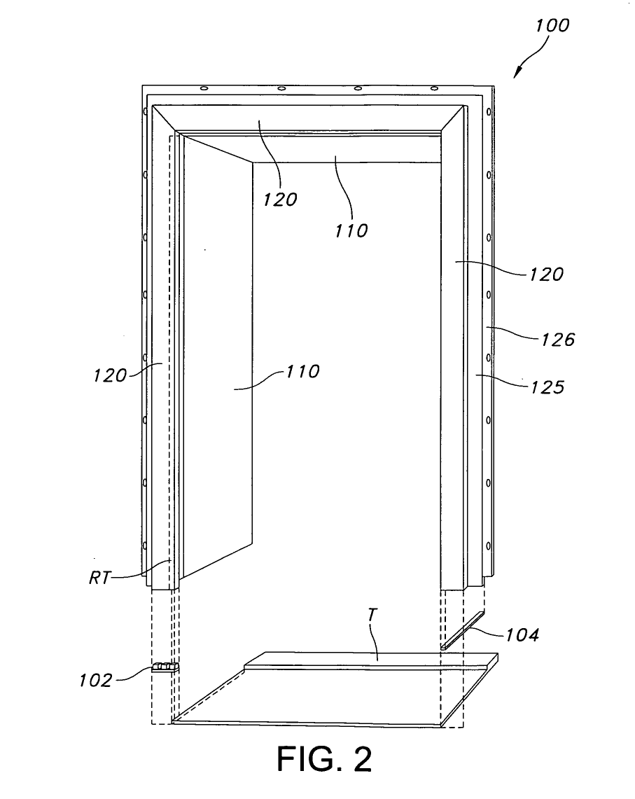

FIG. 2 is a perspective view of the door jamb unit 100, illustrating the jamb section 110, the casing section 120 with a nailing flange 126, assembled as a single unit that includes the jambs and casings along the vertical sides, as well as the header across the top of the door D. Also shown are a casing endcap 102 and a foam gasket 104 that are inserted into the lower openings of the casing section 120 and the jamb section 110, respectively. A reinforcing tube RT may be inserted into the casing section 120, for stiffening the casing and for providing a support for hinges and other mechanisms for a storm door. The reinforcing tube is a conventional component and is not included within the scope of the invention.

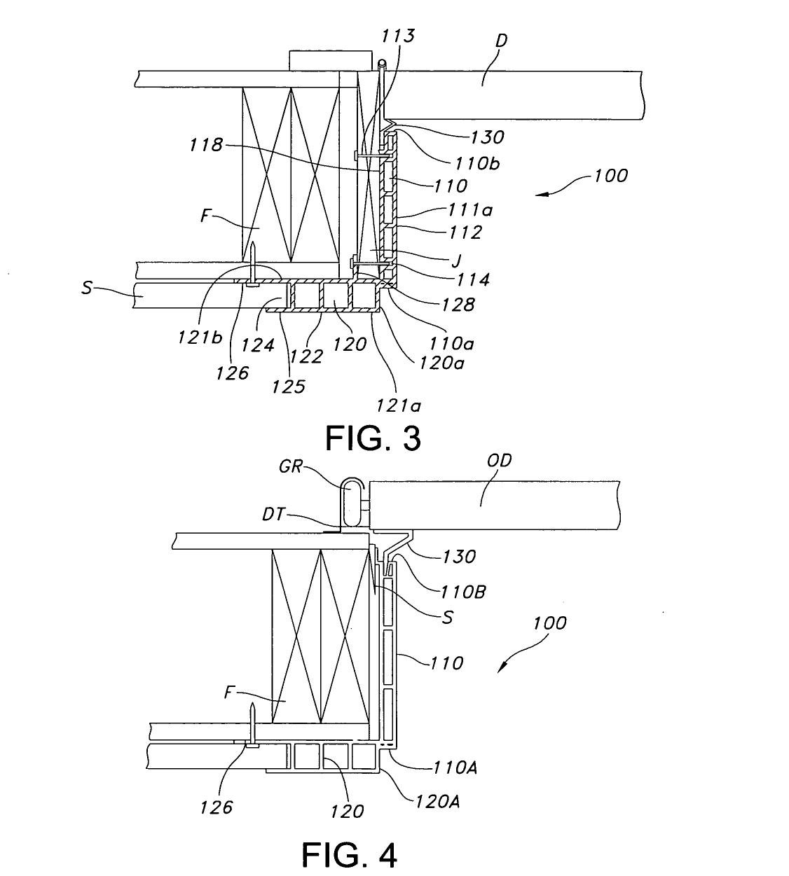

FIG. 3 is a top plane view of the doorjamb unit 100, showing that the door jamb unit 100 is an L-shaped unit that fits around the wall framing F and an interior jamb J. In the embodiment shown, the doorjamb unit 100 is extruded as a single component that includes both the jamb section 110 and the casing section 120. Alternatively, the two sections 110 and 120 may be extruded as separate components and snapped together by means of J-channel connectors or other suitable connectors, before the doorjamb unit 100 is installed in the wall W. Ribs 112 extending between an exterior face 111A and an interior face 111B strengthen the jamb section 110, just as ribs 122 between an exterior casing face 121A and an interior casing face 121B strengthen the casing section 120.

The jamb section 110 is attached to an interior jamb J by means of fasteners 113. A nailing flange 128 is provided on the casing section 120 for securing the doorjamb unit 100 securely to the interior jamb J. A nailing flange 126 having pre-formed nail slots is provided in the casing section 120 for nailing the casing section 120 to wall framing F. The fasteners 113 used with the nailing flanges are conventional fasteners, such as self-drilling screws. The nailing flange 126 and a front flange 125 on the exterior casing face form a channel for receiving conventional outer wall siding S. To simplify installation, a guide groove may be integrated into the nailing flange 128, and a guide groove planed onto the interior jamb J. These guide grooves to serve as a guide for placement of the fasteners 113.

The jamb section 110 has a front vertical face or reveal 110A and a rear vertical face 110B. The casing section 120 has a side vertical face 120A, which, together with the front vertical face 110A forms an L-shaped contour on the exterior face of the doorjamb unit 100 that provides the traditional look of the conventional wood jamb and casing around a door. The rear vertical face 110B faces toward the door D when the doorjamb unit 100 is installed. A seal 130 is attached along the vertical dimension of the interior side face 111 B, which seals a gap between the jamb section 110 and the door D. The seal 130 is a conventional seal with barbs that are pushed past a detent into a slot between the jamb section 110 and the interior jamb J.

As mentioned above, the jamb section 110 and the casing section 120 are used to form the header H above the door D. The header components may be snapped together with the vertical components or they may be heat-welded together to form a mitered corner, as shown in FIG. 1.

FIG. 4 is a top plane view of the doorjamb unit 100 according to the invention, used to enclose the opening for an overhead door OD. The overhead door OD is coupled with a guide roller GR, which is captured in a door track DT. The overhead door, guide roller, and door track are conventional components and are not included in the scope of the invention. Installation of the doorjamb 100 requires no modifications of these conventional components. The casing section 120 and the jamb section 110 are identical to the corresponding sections described above. The seal 130 is a conventional seal system, similar in function to the seal 130 described above, although it may be adapted to accommodate the sliding action of the overhead door OD.

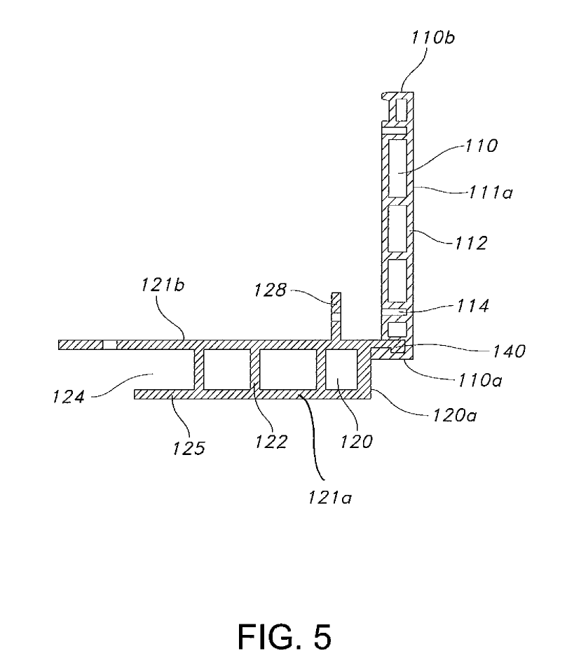

FIG. 5 is a top plane view of the doorjamb unit 100 according to the invention, shown as a two-component construction. The jamb section 110 and the casing section 120 are two separate components that are connected together by means of a J-channel connection 140.

It is understood that the embodiments described herein are merely illustrative of the present invention. Variations in the construction of the door jamb unit may be contemplated by one skilled in the art without limiting the intended scope of the invention herein disclosed and as defined by the following claims.

1: A door jamb unit comprising:
a jamb section and a casing section that form an L-shaped jamb-and-casing assembly that is attachable as a single component to a doorway framing, wherein said jamb section has a front vertical face and said casing section has a side vertical face, said front vertical face said side vertical face adjacent one anther and forming an L-shape face on an exterior face of said jamb-and-casing assembly.

2: The door jamb unit of claim 1, wherein said jamb section has a jamb exterior face and a jamb interior face, and wherein a rib extends from said jamb exterior face to said jamb interior face.

3: The door jamb unit of claim 1, wherein said jamb has a first jamb end and a second jamb end, with a seal at said second jamb end for providing a seal between said second jamb end and a door.

4: The door jamb unit of claim 1, wherein said jamb section and said casing section are extruded as a single integrated component so as to form said single component for attaching to said doorway framing.

5: The door jamb unit of claim 1, wherein said jamb section and said casing section each have a J-channel connector and wherein said door jamb section and said casing section are connectible to each other by said J-channel connector, so as to form said single component prior to attaching to said doorway framing.

6: The door jamb unit of claim 1, wherein said casing section has a casing interior face with a nailing flange and a casing exterior face with a short flange that extends parallel to said nailing flange, and wherein said nailing flange and said short flange form a channel for receiving siding.

7: The door jamb unit of claim 1, said casing section having a casing interior face and a mounting flange that extends perpendicular to said casing interior face.

8: The door jamb unit of claim 7, wherein said mounting flange has a fastener slot.
